(19) United States
(12) Patent Application Publication
(10) Pub. No.: US 2010/0114686 A1
(43) Pub. Date: May 6, 2010

(54) REAL-TIME STATEMENT CREDITS AND NOTIFICATIONS

(76) Inventors: Mark Carlson, Half Moon Bay, CA (US); Surendra Keshan, Cupertino, CA (US); Greg Trifiletti, San Francisco, CA (US); Joe Mirizzi, Copperopolis, CA (US); Prakash Prem Hariramani, San Francisco, CA (US); Lauren White, San Bruno, CA (US); Patrick Stan, Pacifica, CA (US); John Macllwaine, Danville, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/566,350

(22) Filed: Sep. 24, 2009

Related U.S. Application Data
(60) Provisional application No. 61/222,287, filed on Jul. 1, 2009.
(60) Provisional application No. 61/173,483, filed on Apr. 28, 2009.
(60) Provisional application No. 61/100,205, filed on Sep. 25, 2008.

(51) Int. Cl. G06Q 30/00; G06Q 40/00; H04M 11/00

(52) U.S. Cl. 705/14.17; 705/14.23; 379/93.12

(57) ABSTRACT

One embodiment of the invention is directed to a server computer comprising a processor and a computer readable medium coupled to the processor. The computer readable medium comprises code for receiving transaction data indicating that a payment transaction associated with a primary account number has occurred and matches a trigger record, code for determining whether the payment transaction qualifies for a credit, code for initiating a credit to an account associated with the primary account number, if the payment transaction qualifies for a credit, and code for sending an electronic notification message to a consumer associated with the primary account number substantially contemporaneously with receiving the transaction data. The electronic notification message includes information about a first offer and that the primary account was credited the amount of the first offer. For example, transaction data is received indicating that a consumer made a purchase with his credit card. If the purchase was in accordance with a previously sent offer, the consumer's account associated with the credit card is credited and the consumer is immediately notified that the account was credited.

### CROSS-REFERENCES TO RELATED APPLICATIONS

The present application is a non-provisional application of and claims priority to U.S. Provisional Application No. 61/100,205, filed on Sep. 25, 2008 and U.S. Provisional Application No. 61/173,483, filed on Apr. 28, 2009, and U.S. Patent Application No. 61/222,287, filed on Jul. 1, 2009, the entire contents of which are herein incorporated by reference for all purposes.

### BACKGROUND

Coupons are a useful marketing tool to enhance brand loyalty and introduce new products. A coupon provides a flexible incentive for a consumer to purchase a particular product or line of products, or to shop at a particular merchant.

Conventionally, coupons have been available in printed form from sources such as newspapers or direct mailing. There are many drawbacks to printed coupons; the consumer has to cut out the coupon, remember to take the coupon to the store, the merchant and the merchant system have to know to take the coupons, the coupons cannot be tracked (e.g., there is minimal information regarding demographics of consumer redeeming printed coupons) and recovery rate of the coupons cannot be easily predicted. Increased adoption of electronic sources of information such as the world-wide-web has led to the increase in popularity of electronic coupons. However, these electronic coupons typically must be printed out and thus have many of the same drawbacks as conventional printed coupons.

In addition, most consumers now own and operate a mobile phone or other portable electronic device. This renders such consumers accessible to the distribution of electronic coupons as they do their shopping, and moreover allows such distributed electronic coupons to be redeemed directly at the store location.

One problem with electronic coupons is that the recipient of a coupon needs to take the step of actively redeeming the coupon. In a typical scenario, the recipient needs to find the coupon, and present the coupon to the merchant that is providing the benefit of the coupon. Many times, the recipient of the coupon may forget to use the coupon or bring the coupon to the merchant even though the recipient initially had the intention of using the coupon.

Accordingly, there is a need in the art for methods and systems allowing for the distribution and use of electronic coupons by mobile electronic devices that minimize the drawbacks described above. Embodiments of the invention address the above problem and other problems individually and collectively.

### BRIEF SUMMARY

Embodiments of the invention are directed to systems, apparatuses and methods for allowing consumer enrollment and participation in an offer program, real-time offers, and real-time statement credits and notification when a consumer acts in accordance with an offer.

One embodiment of the invention is directed to a server computer comprising a processor and a computer readable medium coupled to the processor. The computer readable medium comprises code for receiving transaction data indicating that a payment transaction associated with a primary account number has occurred and matches a trigger record, code for determining whether the payment transaction qualifies for a credit, code for initiating a credit to an account associated with the primary account number, if the payment transaction qualifies for a credit, and code for sending an electronic notification message to a consumer associated with the primary account number substantially contemporaneously with receiving the transaction data. The electronic notification message includes information about a first offer and that the primary account was credited the amount of the first offer.

Another embodiment of the invention is directed to a method comprising receiving transaction data indicating that a payment transaction associated with a primary account number has occurred and matches a trigger record, determining, using a server computer, whether the payment transaction qualifies for a credit, initiating a credit to an account associated with the primary account number, if the payment transaction qualifies for a credit, and sending an electronic notification message to a consumer associated with the primary account number substantially contemporaneously with receiving the transaction data. The electronic notification message includes information about a first offer and that the primary account was credited the amount of the first offer.

Yet another embodiment of the invention is directed to a method comprising receiving an offer at a phone, conducting a transaction associated with a primary account number using a consumer device, and receiving a notification message at the phone substantially contemporaneously with conducting the transaction. The notification message includes information about the offer and that the primary account was credited the amount of the offer.

Yet another embodiment of the invention is directed to a phone comprising a processor, an antenna coupled to the processor, and a computer readable medium coupled to the processor. The computer readable medium comprises code for receiving an offer and code for receiving a notification message substantially contemporaneously with a payment transaction conducted by a consumer. The notification message relates to a transaction associated with a primary account number and includes information about an offer and that the primary account was credited the amount of the offer.

Yet another embodiment of the invention is directed to a method comprising receiving an offer at a personal navigation device, conducting a transaction associated with a primary account number using a consumer device, and receiving a notification message at the personal navigation device substantially contemporaneously with conducting the transaction. The notification message includes information about the offer and that the primary account was credited the amount of the offer.

Yet another embodiment of the invention is directed to a method comprising receiving an offer at a television, conducting a transaction associated with a primary account number using a consumer device, and receiving a notification message at the television substantially contemporaneously with conducting the transaction. The notification message includes information about the offer and that the primary account was credited the amount of the offer.

These and other embodiments of the invention are described in further detail below.

### BRIEF DESCRIPTION OF THE DRAWINGS

FIG. 1 shows a block diagram of a system according to an embodiment of the invention.

FIG. 2 shows a block diagram of a processing entity according to an embodiment of the invention.

FIG. 3 shows a block diagram of a computer apparatus.

FIG. 4 shows a block diagram of an exemplary mobile phone.

FIG. 5 shows a flowchart illustrating steps in a method according to an embodiment of the invention.

FIG. 6 shows a flowchart illustrating steps in a method according to an embodiment of the invention.

FIG. 7 shows a flowchart illustrating steps in a method according to an embodiment of the invention.

FIG. 8 shows the display on an exemplary mobile phone according to an embodiment of the invention.

FIG. 9 shows the display on an exemplary mobile phone according to an embodiment of the invention.

### DETAILED DESCRIPTION

Embodiments of the invention are directed to systems, apparatuses and methods that allow a consumer to enroll and participate in an offer program and receive real-time statement credits and notifications when the consumer acts in accordance with a real-time offer.

For example, a merchant may set up an offer program or campaign with a processing entity and loyalty system to incentivize consumers to shop at its retail store ACME Foods. The merchant may want to send offers to consumers when they shop at a competing retail store ABC Foods or when they shop at ACME Foods to encourage the consumers to return soon. Optionally a consumer may enroll in an offer program to receive such offers. The offer data and optional consumer enrollment data is sent to a loyalty system. A trigger record, used to detect payment transactions and consumers eligible for an offer or a credit relating to an offer, is sent to a processing entity.

A consumer may next make a purchase at ABC Foods using a credit card. The processing entity determines that this payment transaction (i.e., the purchase at ABC Foods) matches a trigger record and thus is potentially eligible for an offer. The processing entity sends the payment transaction data to the loyalty system. The loyalty system determines whether the payment transaction qualifies for an offer (e.g., the consumer shopped at the competing retail store ABC Foods). If the payment transaction does qualify for an offer, the loyalty system generates an offer (e.g., “$5.00 off your next purchase at ACME Foods”) in accordance with the merchant's campaign goals to incentivize consumers to shop at ACME Foods. An electronic offer message that communicates the offer is then sent to the consumer's mobile device.

After the consumer reviews the offer, and if the consumer makes a subsequent purchase at ACME Foods, the processing entity that receives the transaction data for that subsequent purchase determines that the payment transaction matches a trigger record for a potentially qualifying credit and sends the payment transaction data to the loyalty system. In this subsequent purchase transaction, the consumer does not need to actively present or show the offer to the merchant in order to obtain the benefit of the offer. The loyalty system determines that the payment transaction is eligible for a credit, initiates a credit to the account associated with the consumer's credit card, and sends a notification message to the consumer (e.g., SMS to consumer's phone) that his account has been credited $5.00 for his purchase at ACME Foods. This notification message is sent substantially contemporaneously (e.g., within seconds) of the consumer's purchase at ACME Foods.

Embodiments of the invention have a number of technical advantages and benefits for those involved in the transactions. The merchant benefits, because the consumer shopped at its retail store and it can track the timing of the offer to redemption of the offer. Also, since the merchant's employees do not need to be shown the offer before the benefit associated with the offer is given to the consumer, there is no need to train the merchant's employees on how to redeem offers. This results in increased transaction efficiency and also a reduction of errors (e.g., when employees redeem offers incorrectly). The issuer benefits, because the consumer used his credit card to make the payment transaction. The consumer benefits, because he received an instant $5.00 credit to his account. However, the consumer did not have to remember to actively present the offer to the merchant.

Additional details regarding embodiments of the invention are described below.

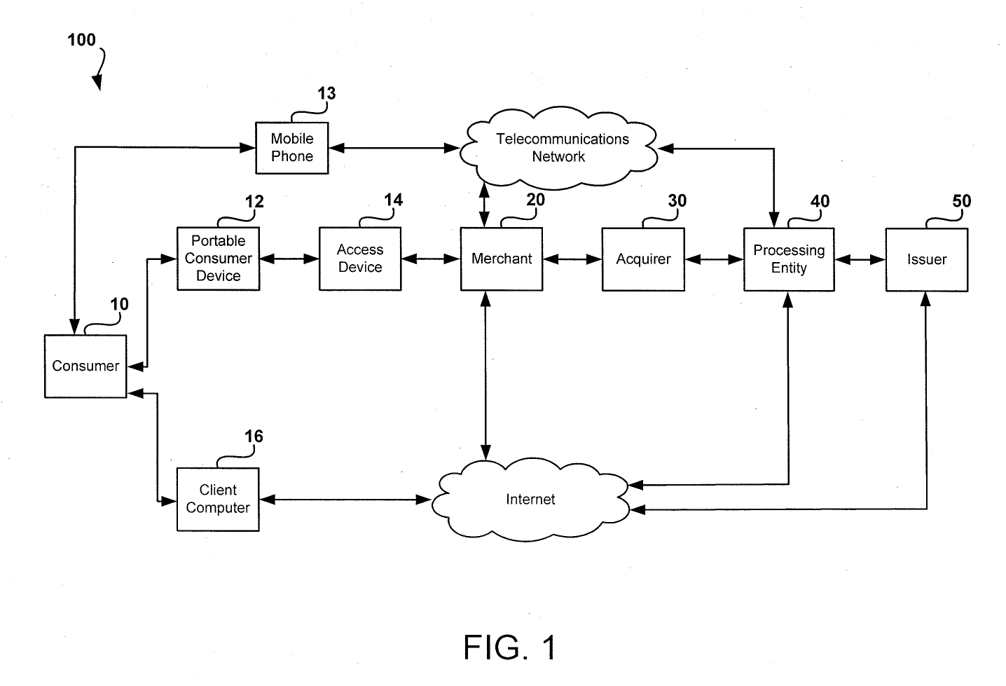

FIG. 1 shows a system that can be used for conducting a payment transaction. For simplicity of illustration, one consumer, one portable consumer device, one mobile phone, one client computer, one access device, one merchant, one acquirer, one processing entity, and one issuer are shown. It is understood, however, that embodiments of the invention may include multiple consumers, consumer devices, client computers, mobile phones, access devices, merchants, acquirers, processing entities, and issuers. In additional, some embodiments of the invention may include fewer than all of the components shown in FIG. 1. Also, the components in FIG. 1 may communicate via any suitable communication medium (including the Internet), using any suitable communication protocol.

The system 100 includes a consumer 10 which may be an individual, or an organization such as a business that is capable of purchasing goods or services. The consumer 10 may operate a client computer 16. The client computer 16 can be a desktop computer, a laptop computer, a wireless phone, a personal digital assistant (PDA), etc. It may operate using any suitable operating system including a Windows™ based operating system. The client computer may be used to interact with a merchant 20 (e.g., via a merchant website).

The consumer 10 may also operate a mobile phone 13. The mobile phone 13 may comprise a processor, an antenna coupled to the processor, and computer readable medium coupled to the processor. The computer readable medium may comprise code for receiving an offer, and code for receiving a notification message substantially contemporaneously with a payment transaction conducted by a consumer, wherein the notification message relates to a transaction associated with a primary account number and includes information about an offer and that the primary account was credited the amount of the offer.

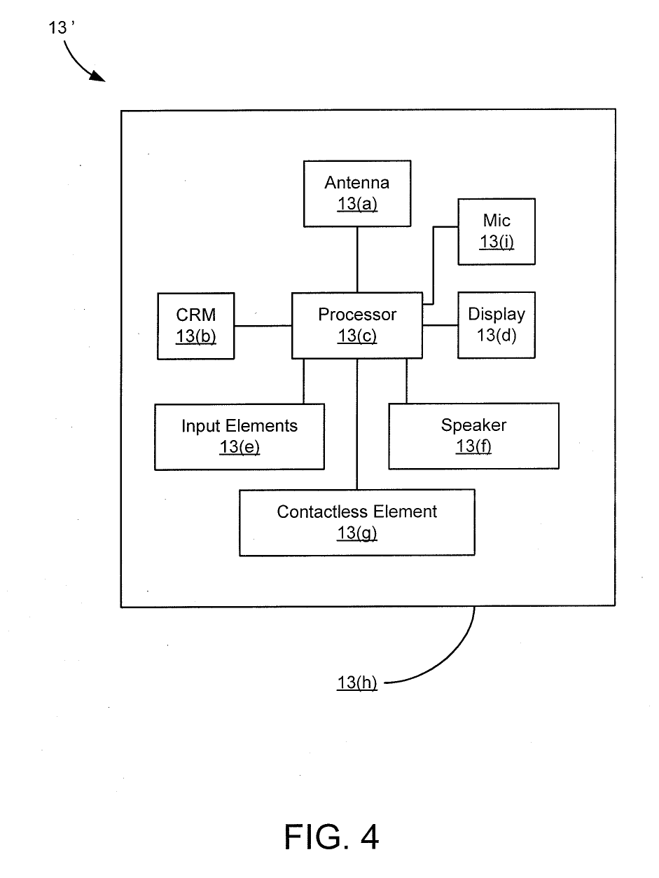

An exemplary mobile phone 13 is shown in FIG. 4. For simplicity of illustration, a specific number of components is shown in FIG. 4. However, it is understood that in other embodiments of the invention, there can be many more components or fewer components. The mobile phone 13 may comprise a computer readable medium 13(b) and a body 13(h). The computer readable medium 13(b) may be present within body 13(h), or may be detachable from it. The body 13(h) may be in the form of a plastic substrate, housing, or other structure. The computer readable medium 13(b) may be a memory that stores data and may be in any suitable form including a magnetic stripe, a memory chip, etc. The memory preferably stores information such as financial information. Financial information may include information such as bank account information, bank identification number (BIN), credit or debit card information, account balance information, expiration date, consumer information such as name, date of birth, etc. Any of this information may be transmitted by the mobile phone 13′.

The computer readable medium 13(b) may comprise code for receiving an offer, code for displaying an offer, code for conducting a payment transaction, code for receiving a notification message substantially contemporaneously with a payment transaction conducted by a consumer, wherein the notification message relates to a transaction associated with a primary account number and includes information about an offer and that the primary account was credited the amount of the offer, and code for displaying a notification message. It may also comprise code for sending an authorization request message and receiving an authorization response message from the issuer and code for displaying an authorization response message.

The mobile phone 13′ may further include a contactless element 13(g), which is typically implemented in the form of a semiconductor chip (or other data storage element) with an associated wireless transfer (e.g., data transmission) element, such as an antenna. Contactless element 13(g) is associated with (e.g., embedded within) mobile communication device 13′ and data or control instructions transmitted via a cellular network may be applied to contactless element 13(g) by means of a contactless element interface (not shown). The contactless element interface functions to permit the exchange of data and/or control instructions between the mobile phone circuitry (and hence the cellular network) and an optional contactless element 13(g).

Contactless element 13(g) is capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the mobile phone 13′ and a processing entity 40. Thus, the mobile phone 13′ is capable of communicating and transferring data and/or control instructions via both cellular network and near field communications capability.

The mobile communication device 13′ may also include a processor 13(c) (e.g., a microprocessor) for processing the functions of the mobile phone 13′ and a display 13(d) to allow a consumer to see phone numbers, graphics, and other information and messages. The mobile phone 13′ may further include input elements 13(e) to allow a consumer to input information into the phone, a speaker 13(f) to allow the consumer to hear voice communication, music, etc., and a microphone 13(i) to allow the consumer to transmit his or her voice through the mobile phone 13′. The mobile phone 13′ may also include an antenna 13(a) for wireless data transfer (e.g., data transmission).

Returning to FIG. 1, the consumer device 12 may be in any suitable form. For example, suitable consumer devices can be hand-held and compact so that they fit into a consumer's wallet and/or pocket (e.g., pocket-sized). They may include smart cards, ordinary credit or debit cards (with a magnetic strip and without a microprocessor), keychain devices (such as the Speedpass™ commercially available form Exxon-Mobil Corp.), etc. Other examples of portable consumer devices include mobile phones, PDAs, pagers, payment cards, security cards, access cards, smart media, transponders, and the like. The consumer devices can also be debit services (e.g., a debit card), credit devices (e.g., a credit card), or stored value devices (e.g., a stored value card).

The merchant 20 may be an individual or an organization such as a business that is capable of providing goods and services. The merchant 20 may have a computer apparatus (not shown). The computer apparatus may comprise a processor and a computer readable medium. The computer readable medium may comprise code or instructions for sending an authorization request message, receiving an authorization response message, and displaying an authorization response message.

The merchant 20 may have one or more access devices 14. Suitable access devices include interfaces and may include point of sale (POS) devices, cellular phones, PDAs, personal computers (PCs), tablet PCs, handheld specialized readers, set-top boxes, electronic cash registers (ECR), automated teller machines (ATM), virtual cash registers (VCR), kiosks, security systems, access systems, and the like. They can interact with consumer devices. For example, a consumer 10 using a credit card to purchase a good or service can swipe it through an appropriate slot in the POS terminal. Alternatively the POS terminal may be a contactless reader, and the consumer device 12 may be a contactless device such as a contactless card. As another alternative, a consumer 10 may purchase a good or service via a merchant's website where the consumer enters the credit card information into the client computer 16 and clicks on a button to complete the purchase. The client computer 16 may be considered an access device.

The system 100 also includes an acquirer 30 associated with the merchant 20. The acquirer 30 may be in operative communication with an issuer 50 of the consumer device 12 via a payment processing network 40. The acquirer 30 is typically a bank that has a merchant account. The issuer 50 may also be a bank, but could also be a business entity such as a retail store. Some entities are both acquirers and issuers, and embodiments of the invention include such entities. The acquirer 30 and the issuer 50 may each have a server computer and a database associated with the server computer (not shown).

The processing entity 40 is located between (in an operational sense) the acquirer 30 and the issuer 50. It may include data processing subsystems, networks, and operations used to support and deliver authorization services, exception file services, and clearing and settlement services. For example, a processing entity may include VisaNet™. Processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

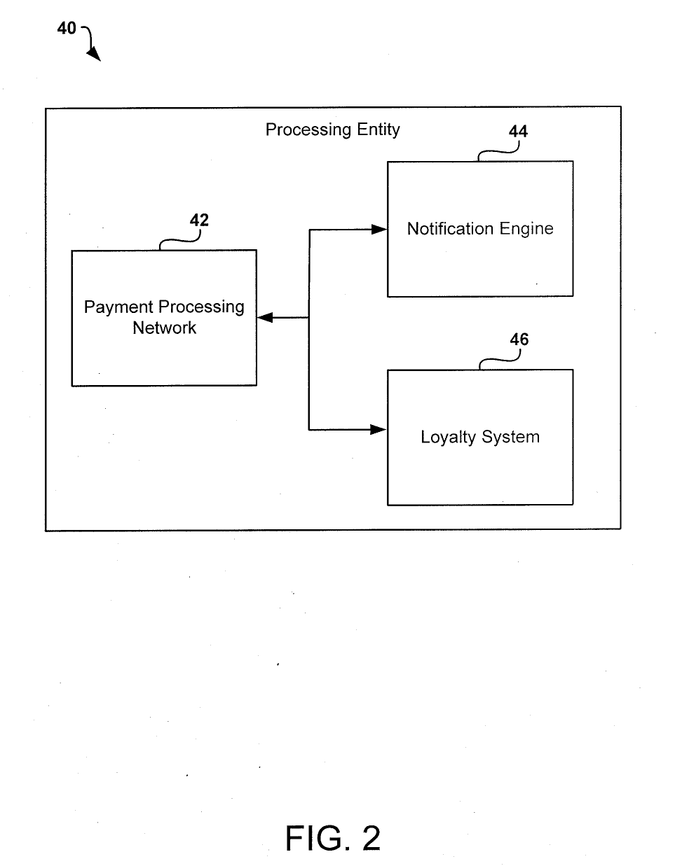

A block diagram showing some components that may be in an exemplary processing entity is shown in FIG. 2. The processing entity 40 may include a payment processing network 42, a notification engine 44, and a loyalty system 46. Although these entities are all shown as part of the processing entity, it is understood that each entity could alternatively be entirely separate entities or that some combination of entities could be included in the processing entity and some could be external to the processing entity.

The processing entity 40, or any components thereof may, operate a server computer which includes a processor and a computer readable medium coupled to the processor, the computer readable medium comprising code for receiving transaction data indicating that a payment transaction associated with a primary account number has occurred and matches a trigger record, code for determining whether the payment transaction qualifies for a credit, code for initiating a credit to an account associated with the primary account number, if the payment transaction qualifies for a credit, and code for sending an electronic notification message to a consumer associated with the primary account number substantially contemporaneously with receiving the transaction data, wherein the electronic notification message includes information about a first offer and that the primary account was credited the amount of the first offer.

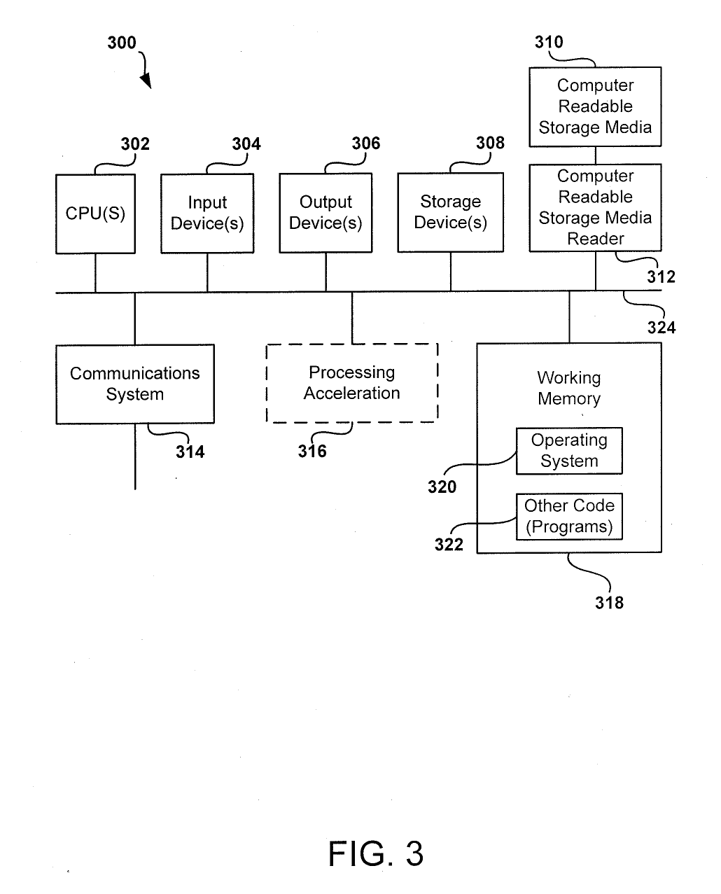

FIG. 3 illustrates an exemplary computer system 300, in which various embodiments may be implemented. The system 300 may be used to implement any of the computer systems described above (e.g., client computer 16, a server computer at the processing entity 40, a server computer at the issuer 50, a computer apparatus at the merchant 20, etc.). The computer system 300 is shown comprising hardware elements that may be electrically coupled via a bus 324. The hardware elements may include one or more central processing units (CPUs) 302, one or more input devices 304 (e.g., a mouse, a keyboard, etc.), and one or more output devices 306 (e.g., a display device, a printer, etc.). The computer system 300 may also include one or more storage devices 308. By way of example, the storage device(s) 308 can include devices such as disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 312, a communications system 314 (e.g., a modem, a network card (wireless or wired), an infra-red communication device, etc.), and working memory 318, which may include RAM and ROM devices as described above. In some embodiments, the computer system 300 may also include a processing acceleration unit 316, which can include a digital signal processor DSP, a special-purpose processor, and/or the like.

The computer-readable storage media reader 312 can further be connected to a computer-readable storage medium 310, together (and, optionally, in combination with storage device(s) 308) comprehensively representing remote, local, fixed, and/or removable storage devices plus storage media for temporarily and/or more permanently containing, storing, transmitting, and retrieving computer-readable information. The communications system 314 may permit data to be exchanged with the network and/or any other computer described above with respect to the system 300.

The computer system 300 may also comprise software elements, shown as being currently located within a working memory 318, including an operating system 320 and/or other code 322, such as an application program (which may be a client application, Web browser, mid-tier application, RDBMS, etc.). It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

In one embodiment of the invention, a merchant 20 may set up on offer via a processing entity 40 and loyalty system 46. A merchant may set up an offer to be sent out to all consumers, only consumers enrolled in an offer program, or a subset of consumers based upon predetermined criteria (e.g., consumers in a certain geographic area, consumers with a certain transaction history, consumers in a particular age range, etc.). For example, a merchant may set up an offer for a discount off of a consumer's next purchase (e.g., $2.00 off next purchase at ACME Foods), a discount on a next purchase if it exceeds a predetermined amount (e.g., 10% off a purchase over $25.00), a discount on a next purchase that is made within in predetermined time period (e.g., 15% off any purchase before noon, 20% off a purchase made during non-peak business hours for the merchant (e.g., 3 pm-5 pm during the weekdays)), a discount on a next purchase at a competing merchant (e.g., consumer makes purchase at competitor, an offer is sent to the consumer for 20% purchase at the merchant's store), a discount after a predetermined number of purchases is made (e.g., 10% off of a 5th purchase, or buy 4 sandwiches and get the 5th free), etc.

As noted above, in some embodiments, an offer (e.g., a first offer, or subsequent offer) is associated with a merchant, and the characteristics of the first are dependent upon non-peak demand times for the merchant. The characteristics of the offer may relate to the timing and/or value of the offer. For example, the loyalty system may store rules which are defined by the merchant which indicate that offers of greater value will be sent to consumers just before non-peak time periods, or that offers can only be redeemed during non-peak periods, so that consumers are more likely to make purchases during non-peak time periods. Such rules can help drive sales during non-peak sales periods for merchants. In some embodiments it is possible for the benefit associated with the offer to be in the form of a statement credit or even loyalty points.

There are a number of ways that a merchant 20 can set up an offer via a loyalty system 46. For example, the merchant 20 can set up the offer via a web browser, can send or upload a file, can call the processing entity or loyalty system directly, etc. Once the merchant 20 has set up an offer, a database at the processing entity 40 is updated with the offer information.

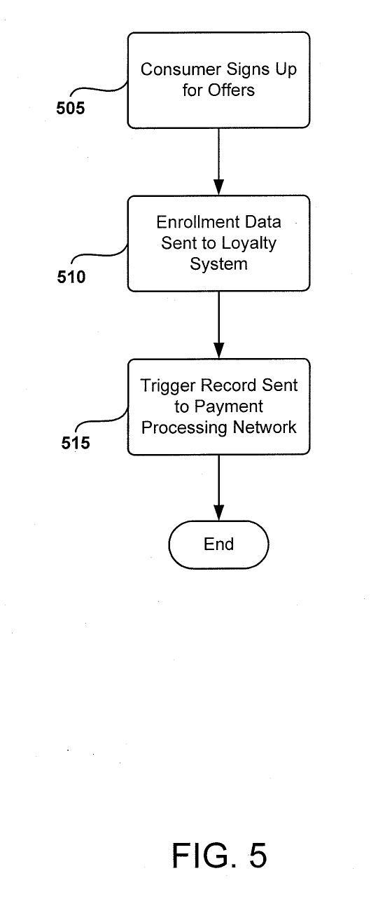

FIG. 5 shows a flowchart including a general method according to an embodiment of the invention. The method including an enrollment process and can be described with reference to the block diagrams in FIGS. 1-2.

An offer may be sent to a consumer 10 in response to the consumer's transaction activity, the consumer's location, and/or the consumer's registration in an offer campaign (step 505). The consumer 10 may sign up for offers at either an issuer 50 or a processing entity 40 through a web interface such as a web browser (e.g., on client computer 16), by calling the processing entity 40 or issuer 50 directly, or by sending an SMS or email to the issuer 50 or processing entity 40. The consumer may supply information such as a primary account number (PAN), preferences, contact information, etc.

The consumer enrollment data is then sent to the loyalty system 46 (step 510). This information can be sent via web service, in batch, individually, etc. A trigger record is also sent to the payment processing network 42 (step 515) that tells the payment processing network 42 that if it sees a transaction for the enrolled account(s), to notify the loyalty system 46.

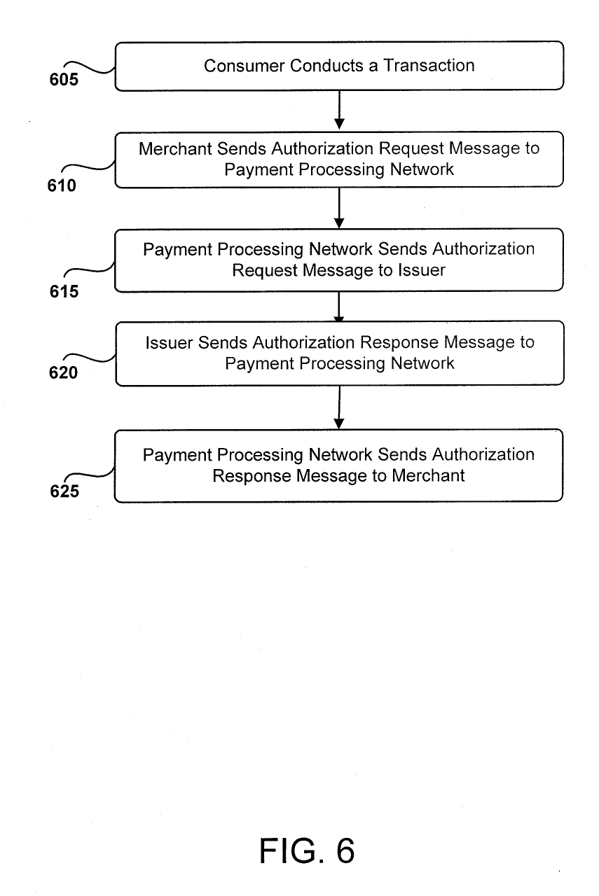

FIG. 6 shows a flowchart including a general method according to an embodiment of the invention. The method can include a payment process and can be described with reference to the block diagrams in FIGS. 1-2.

In a typical payment transaction, the consumer 10 conducts a transaction (step 605) by purchasing a good or service at the merchant 20 using a portable consumer device 12 (e.g., credit card). The consumer's portable consumer device 12 can interact with an access device such as a POS (point of sale) terminal at the merchant 20. For example, the consumer 10 may take a credit card and may swipe it through an appropriate slot in the POS terminal. Alternatively, the POS terminal may be a contactless reader, and the portable consumer device 12 may be a contactless device such as a contactless card or a mobile phone with a contactless element. The consumer can also conduct a transaction using a mobile phone 13 or a client computer 16 via the Internet or telecommunications network.

An authorization request message is then sent to the payment processing network 42 (step 610) (which may be sent via the acquirer 30). The payment processing network 42 then forwards the authorization request message to the issuer 50 of the portable consumer device 12 (step 615).

After the issuer 50 receives the authorization request message, the issuer 50 sends an authorization response message back to the payment processing network 42 to indicate whether or not the current transaction is authorized (step 620). The payment processing network 42 then forwards the authorization response message back to the merchant 20 (which may be sent via the acquirer 30) (step 625).

After the merchant 20 receives the authorization response message, the access device at the merchant 20 may then provide the authorization response message for the consumer 10. The response message may be displayed by the POS terminal, the portable consumer device 12, a mobile phone 13, a client computer 16, or may be printed out on a receipt.

At the end of the day, a normal clearing and settlement process can be conducted by the payment processing network 42. A clearing process is a process of exchanging financial details between an acquirer and an issuer to facilitate posting to a consumer's account and reconciliation of the consumer's settlement position. Clearing and settlement can occur simultaneously.

At step 610 the processing entity 40 may also determine whether the payment transaction (e.g., from data contained in the authorization request message) matches a trigger record indicating that the consumer associated with the payment transaction may be eligible to receive an offer. A trigger record may include a primary account number associated with consumer enrolled in an offer program, a primary account number associated with a targeted consumer (e.g., consumers in a certain geographic area, consumers in a particular age range, etc.), and/or certain transaction history or activity (e.g., a merchant may be targeting all consumers that purchase coffee, thus, a transaction that includes the purchase of coffee may be the trigger record that indicates that the consumer may be eligible to receive an offer).

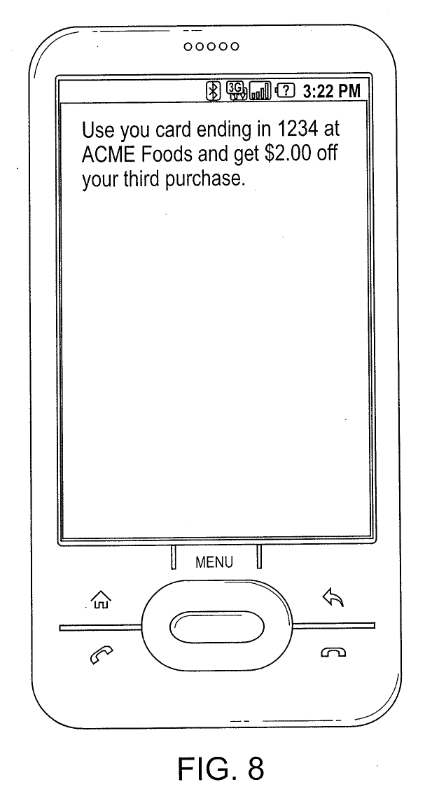

If the payment transaction matches a trigger record, then the processing entity 40 sends the transaction data, including merchant data, to the loyalty system 46. The loyalty system 46 then determines whether an offer should be sent to the consumer 10 associated with the payment transaction. The loyalty system 46 may make this determination based upon transaction activity/history, the date of the campaign, location of the consumer, or any other suitable means. If the loyalty system 46 determines that an offer should be sent to the consumer 10, the loyalty system 46 generates an offer and sends the offer in the form of an offer message to the consumer 10. The offer may be sent as an SMS, email, IP or push notification means (e.g., via RIM Push Network), or other suitable means. The consumer 10 may receive the offer via his mobile phone 13, portable consumer device 12, or client computer 16. Other examples of devices that may receive an offer include wired telephones, televisions, personal digital assistants (PDAs), personal navigation devices (e.g., Garmin, TeleNav), pagers, and the like. FIG. 8 shows an example of what a consumer 10 may see on his device when he receives the offer.

After sending the offer, the loyalty system 46 can continue to monitor transactions to determine whether the consumer 10 acts in accordance to the offer sent to him and thus qualifies for an account credit.

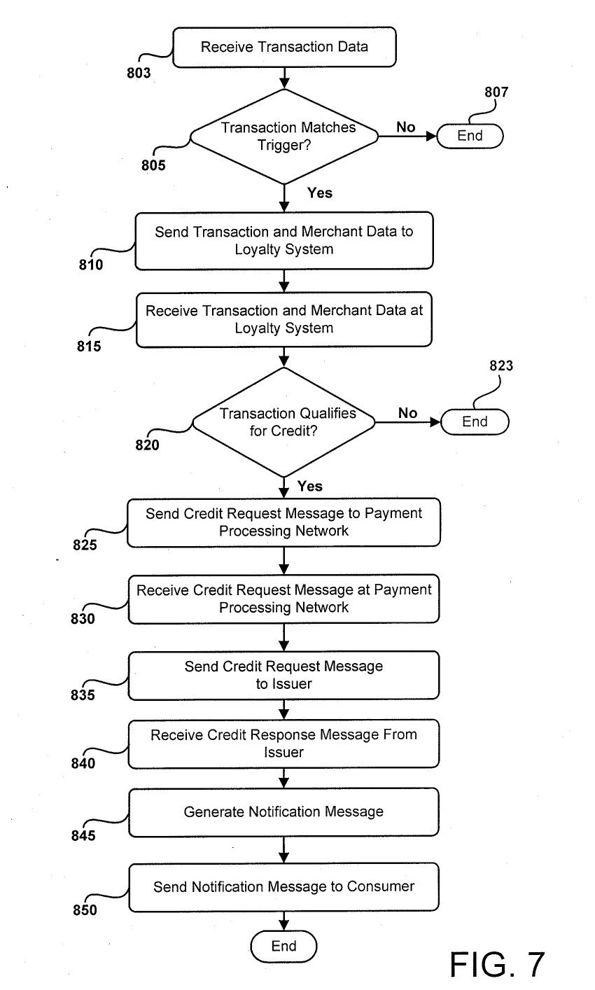

FIG. 7 shows a flowchart including a general method according to an embodiment of the invention. The method can be described with reference to the block diagrams in FIGS. 1-2.

As indicated above, the payment processing network 42 receives transaction data (step 803) when it receives the authorization request message from the merchant 20 (e.g., as shown in FIG. 6, step 610). The payment processing network 42 then determines (using a server computer located at the payment processing network 42) whether the transaction data matches a trigger record (step 805) that indicates that the account associated with the payment transaction may be eligible for an account credit. For example, a consumer 10 associated with a primary account number for the payment transaction may have previously enrolled in program to receive offers and a credit to his account when he acts in accordance with a particular offer. The trigger record may contain the account number for this consumer. Another example is where a merchant 20 may have set up an offer to target all consumers that purchase coffee. Thus, the trigger records may contain account numbers for consumers whose transaction activity indicates that they purchase coffee (e.g., shop at coffee shops or purchase coffee at a grocery store).

If the payment transaction does not match a trigger record, then the process ends (step 807). If the payment transaction does match a trigger, then the payment processing network 42 sends the transaction data, including merchant data, to the loyalty system 46 (step 810). The loyalty system 46 receives the transaction data (step 815) and then determines whether the payment transaction qualifies for a credit (step 820). The payment transaction qualifies for a credit if it matches activity in accordance with a previously sent offer. For example, the consumer 10 may have previously received an offer via SMS to his phone “Use your card ending in 1234 at ACME Foods and get $2.00 off your third purchase,” as shown in FIG. 8. The loyalty system 46 will be tracking the consumer's purchase activity to see if he has been making purchases at ACME Foods. The loyalty system 46 may also receive an indication from the consumer's phone that the consumer 10 actually viewed the offer. If the consumer 10 is making a third purchase at ACME Foods, this payment transaction will qualify for a credit. If the transaction does not qualify for a credit, the process ends (step 823).

If the payment transaction does qualify for a credit (e.g., the consumer has made a third purchase at ACME Foods), then the loyalty system 46 initiates a credit to an account associated with the primary account number used by the consumer 10 to conduct the payment transaction. The loyalty system 46 sends a credit request message to the payment processing network 42 (step 825). The payment processing network 42 receives the credit request message (step 830) and sends the credit request message to the issuer 50 (step 835) of the account associated with the payment transaction. The issuer 50 sends a credit response message to the payment processing network 42 indicating whether or not the credit was successful. The payment processing network 42 receives the credit response message from the issuer 50 (step 840).

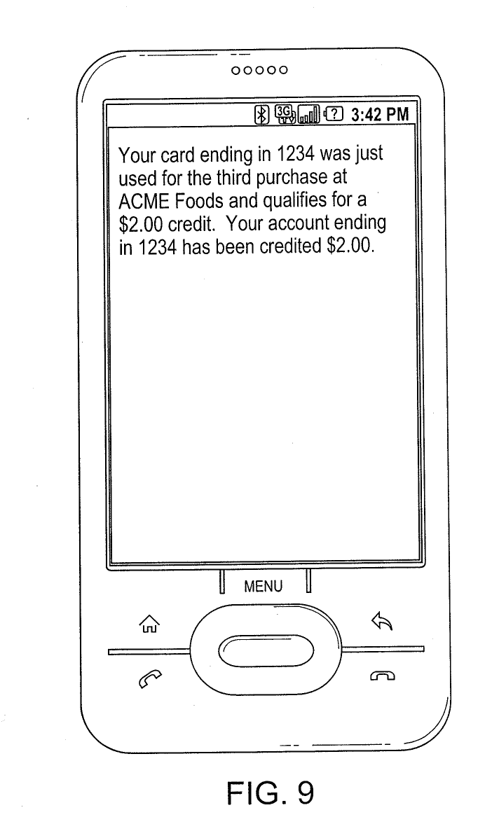

The loyalty system 46 then generates a notification message to send to the consumer to indicate that his payment transaction qualified for a credit (step 845). The notification message may also indicate the amount of the credit, whether the credit was successful, and details of the offer and the payment transaction associated with the credit. The notification message is sent to the consumer via the payment processing network 42 (step 850). The notification message may be sent as an SMS, email, IP or push notification means (e.g., via RIM Push Network), or other suitable means. The consumer 10 may receive the notification message at his client computer 16, portable consumer device 12, or mobile phone 13. Other examples of devices that may receive a notification message include wired telephones, televisions, personal digital assistants (PDAs), personal navigation devices (e.g., Garmin, TeleNav), pagers, and the like. An exemplary notification message is shown in FIG. 9. The notification message may be sent substantially contemporaneously (e.g., within 10, 5 or 2 seconds of the initiation of the transaction or the sending of the authorization request message by the merchant) with the payment processing network 42 receiving the authorization request message (e.g., when the consumer conducts the transaction).

In some embodiments, since the loyalty system 46 received an indication that the consumer 10 viewed the offer and received an indication that the consumer 10 acted on the offer, the merchant providing the offer knows that the offer was effective, and that the consumer 10 did not simply happen to get the credit without knowing about the offer. This advantageously allows the merchant and the loyalty system 46 to determine if the offers that are sent to consumers are effective and are consequently worth the expense and effort in sending.

At step 805 the processing entity 40 also determines whether the payment transaction matches a trigger record and thus the consumer associated with the payment transaction should receive a second offer. The process of determining whether to send a second offer and sending the second offer is the same as described above.

The above embodiments describe sending a separate credit request message to initiate the credit to the account associated with the payment transaction that qualifies for a credit. It is it is understood that the credit request could be sent as one message at the same time the authorization request message is sent by the payment processing network to the issuer in FIG. 6, step 615. For example, the authorization request message would include a request to authorize the payment transaction, and if the payment transaction is authorized, a request to credit the account the amount of the offer.

In some embodiments the portable consumer device and the mobile phone can be embodied in the same device. For example, the mobile phone may function as both a portable consumer device that can be used to pay for goods or services, and a notification device to notify the consumer that their purchase qualified for an offer, the amount of the offer (e.g. how much), and that the credit has been initiated to their account. In other embodiments the portable consumer device and the device that receives the notification message may be separate devices. For example a consumer may conduct a payment transaction with a portable consumer device such as a credit card and then receive notification of an offer or credit to the account associated with the credit card at his mobile phone.

As indicated above, in some embodiments a consumer 10 can receive offers and notification messages via a personal navigation device (e.g., Garmin, TeleNav). The personal navigation device may comprise a processor, an antenna coupled to the processor, and computer readable medium coupled to the processor. The computer readable medium may comprise code for receiving an offer, and code for receiving a notification message substantially contemporaneously with a payment transaction conducted by a consumer, wherein the notification message relates to a transaction associated with a primary account number and includes information about an offer and that the primary account was credited the amount of the offer.

As also indicated above, in some embodiments a consumer 10 can receive offers and notification messages via a television. For example, a consumer 10 is watching a prime time show on television and receives an offer for a dress that a character is wearing. The consumer 10 may use the remote control to shop for the dress in the offer. After completing the purchase of the dress, the consumer 10 may receive a notification at the television substantially contemporaneously with the purchase of the dress.

The following are exemplary use cases that can be used in various embodiments.

Get Spend Up (transaction based offer). A merchant or other entity (e.g., Guckenheimer) may set up an offer program or campaign with a processing entity to get consumers who spend only small amounts of money at the merchant to spend more. The merchant may have a marketing budget of $10,000 for the campaign. When a consumer conducts a transaction at Guckenheimer the system checks if the potential redemption (e.g., the merchant's campaign budget) is less than $10,000 (and thus more offers can be made) and also checks to be sure that the consumer has no outstanding “Get Spend Up” offers already from Guckenheimer. If the consumer's transaction at Guckenheimer is approved and the amount of the transaction is less than $2.00, then the consumer will immediately receive an offer (e.g., via SMS at his phone) stating “If your next Guckenheimer purchase is over $3.00 then you will receive a 0.50 cent instant credit.”

The next time that the consumer conducts a transaction at Guckenheimer, the system will detect that the consumer has an unfulfilled/unexpired “Get Spend Up” offer. If the consumer's transaction is approved and the transaction amount is over $3.00, then the consumer immediately receives notification (e.g., via SMS at his phone): “Your last purchase of $4.00 at Guckenheimer just qualified for a 0.50 cent credit. Check your next statement.” The system then marks the “Get Spend Up” offer as “fulfilled” for the consumer. The system can optionally push 0.50 cents to the consumer.

Hump Day—Instant Offer. A merchant or other entity (e.g., Guckenheimer) may set up an offer program or campaign with a processing entity to incentivize a consumer to shop on a particular day or a particular time (e.g., dinner on Mother's day, lunch on Wednesday, etc.). The merchant may have a marketing budget of $1,000 for the campaign. When a consumer conducts a transaction, the system checks if the potential redemption (e.g., the merchant's campaign budget) is less than $1,000 (and thus more offers can be made), checks to be sure that the consumer has no outstanding “Hump Day” offers already from Guckenheimer, and checks if the transaction is occurring Wednesday before 11:30 am. If the consumer's transaction is approved, then the consumer will immediately receive an offer (e.g., via SMS at his phone) stating “Buy Lunch at Guckenheimer today and you will receive a $1 instant credit.”

The next time that the consumer conducts a transaction at Guckenheimer, the system will detect that the consumer has an unfulfilled/unexpired “Hump Day” offer. If the consumer's transaction is approved and the transaction amount is over $1.00, then the consumer immediately receives notification (e.g., via SMS at his phone): “Your last purchase of $6.50 at Guckenheimer just qualified for a $1.00 credit. Check your next statement.” The system then marks the “Hump Day” offer as “fulfilled” for the consumer. The system can optionally push $1.00 to the consumer.

Affiliate. A merchant or other entity (e.g., Starbucks) may set up an offer program or campaign with a processing entity to get consumers who shop at one merchant to shop at an affiliated merchant. The merchant may have a marketing budget of $10,000 for the campaign. When a consumer conducts a transaction at Guckenheimer the system checks if the potential redemption (e.g., the merchant's campaign budget) is less than $10,000 (and thus more offers can be made) and also checks to be sure that the consumer has no outstanding “Affiliate” offers already from Starbucks. If the consumer's transaction at Guckenheimer is approved, then the consumer will immediately receive an offer (e.g., via SMS at his phone) stating “Make a Foster City Starbucks (not Metro) purchase in the next 2 hours and receive $2.00 off any purchase of $3.00.”

The next time that the consumer conducts a transaction at Starbucks, the system will detect that the consumer has an unfulfilled/unexpired “Affiliate” offer. If the consumer's transaction is approved, the transaction amount is over $3.00, and the purchase occurred within 2 hours of the offer, then the consumer immediately receives notification (e.g., via SMS at his phone): “Your last purchase of $5.00 at Foster City Starbucks just qualified for a $2.00 credit. Check your next statement.” The system then marks the “Affiliate” offer as “fulfilled” for the consumer. The system can optionally push $2.00 to the consumer.

Merchant Rewards/Point Program (e.g., 5th purchase is free up to $2.00). A merchant or other entity (e.g., Guckenheimer) may set up an offer program or campaign with a processing entity to get consumers to regularly shop at the merchant. A consumer may have the option to enroll in the Rewards program. The merchant may have a marketing budget of $10,000 for the campaign. When a consumer conducts a transaction at Guckenheimer the system checks if the potential redemption (e.g., the merchant's campaign budget) is less than $10,000 (and thus more offers can be made). If the consumer's transaction at Guckenheimer is approved, the amount of the transaction is greater than $2.00, and it is the 4th purchase, then the consumer will immediately receive an offer (e.g., via SMS at his phone) stating “Your next Guckenheimer purchase over $2.00 will qualify for a $2.00 instant credit.”

The next time that the consumer conducts a transaction at Guckenheimer, the system will detect that the consumer is still active in the Rewards program. If the consumer's transaction is approved, the transaction amount is over $2.00, and if it is the 5th purchase, then the consumer immediately receives notification (e.g., via SMS at his phone): “Your last purchase of $4.00 at Guckenheimer just qualified for a $2.00 instant credit. Check your next statement.” The system then resets the rewards counter for the consumer. The system can optionally push $2.00 to the consumer.

Location Based Offer. A merchant or other entity (e.g., Home Depot) may want to send an offer to a consumer anytime they are within a certain distance (e.g., 200 yards, 1 mile, etc.) of its competitor (e.g., Lowes). The merchant may have a marketing budget of $10,000 for the campaign. When a consumer conducts a transaction at Home Depot, the system will detect that the consumer is within a certain distance from Lowes. The consumer immediately receives notification (e.g., via SMS at his phone) stating: “Receive 20% off your next purchase at Lowes.”

The next time the consumer conducts a transaction at Lowes, the system will detect that the consumer has an unfulfilled/unexpired “Location Base Offer” for Lowes. If the consumer's transaction is approved then the consumer immediately receives notification (e.g., via SMS at his phone): “Your last purchase of $55.00 at Lowes just qualified for a 20% credit. Check your next statement.” The system then marks the “Location Based offer” as “fulfilled” for the consumer. The system can optionally push the 20% credit to the consumer.

At the end of the day, a normal clearing and settlement process can be conducted by the payment processing network. A clearing process is a process of exchanging financial details between an acquirer and an issuer to facilitate posting to a consumer's account and reconciliation of the consumer's settlement position. Clearing and settlement can occur simultaneously.

Embodiments of the invention provide a number of advantages. As noted above, a merchant or entity setting up an offer campaign can easily send targeted offers to consumer based on transaction activity, consumer location, and to consumers who enrolled to receive offers. There is an increased chance that a consumer will act on an offer because he does not need to print or cut out a coupon, or remember to bring a coupon with him to the store, or even remember that he has a coupon since his account associated with a payment transaction that qualifies for a credit will be credited automatically when he acts in accordance with the offer. The consumer will be pleased when he receives his instant credit which will make it more likely that he will shop at the merchant again or buy the particular product again. The merchant can easily track which offers are effective and can better determine when a consumer acts in accordance to an offer. For example, the exemplary offer in FIG. 8 is sent to the consumer at 3:22 PM and the merchant knows that the consumer acted upon the offer when the consumer makes a purchase and account is credited as show in FIG. 9 which shows the notification to the consumer at 3:42 PM. Thus, the merchant can better determine success rate of an offer and plan for future offer campaigns. The issuer of the consumer's account associated with the payment transaction is also satisfied because the consumer may use his account more often if he is receiving desirable offers. Moreover, because there is no active presentation of an offer to the merchant, the merchant's employees do not need to be trained to redeem offers, thus resulting in improved and more accurate benefit processing. Lastly, a merchant does not have to keep track of the coupons and redemption of the coupons which greatly reduces merchant overhead.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A server computer comprising:
a processor; and
a computer readable medium coupled to the processor, the computer readable medium comprising code for receiving transaction data indicating that a payment transaction associated with a primary account number has occurred and matches a trigger record, code for determining whether the payment transaction qualifies for a credit, code for initiating a credit to an account associated with the primary account number, if the payment transaction qualifies for a credit, and code for sending an electronic notification message to a consumer associated with the primary account number substantially contemporaneously with receiving the transaction data, wherein the electronic notification message includes information about a first offer and that the primary account was credited the amount of the first offer.

2. The server computer of claim 1 wherein the computer readable medium further comprises code for determining whether the consumer qualifies for a second offer, and code for sending the second offer to the consumer associated with the primary account number if the consumer qualifies for the second offer.

3. The server computer of claim 2 wherein determining whether the consumer qualifies for a second offer is based upon the consumer's transaction activity.

4. The server computer of claim 1 wherein the first offer is associated with a merchant, and wherein the characteristics of the first offer are dependent upon non-peak demand times for the merchant.

5. The server computer of claim 1 wherein the computer readable medium further comprises code for receiving a message that the credit to the account associated with the primary account number was successful.

6. The server computer of claim 1 wherein the trigger record includes a primary account number of a consumer who previously enrolled in a system to receive offers.

7. A method comprising:
receiving transaction data indicating that a payment transaction associated with a primary account number has occurred and matches a trigger record;
determining, using a server computer, whether the payment transaction qualifies for a credit;
initiating a credit to an account associated with the primary account number, if the payment transaction qualifies for a credit; and
sending an electronic notification message to a consumer associated with the primary account number substantially contemporaneously with receiving the transaction data, wherein the electronic notification message includes information about a first offer and that the primary account was credited the amount of the first offer.

8. The method of claim 7 further comprising:
determining, using the server computer, whether the consumer qualifies for a second offer; and
sending the second offer to the consumer associated with the primary account number if the consumer qualifies for the second offer.

9. The method of claim 8 wherein determining whether the consumer qualifies for a second offer is based upon the consumer's transaction activity.

10. The method of claim 7 wherein determining whether the payment transaction qualifies for a credit is based upon the consumer's transaction activity.

11. The method of claim 7 further comprising receiving a message that the credit to the account associated with the primary account number was successful.

12. The method of claim 7 wherein the electronic notification message is sent via SMS, email or push notification.

13. The method of claim 7 wherein the trigger record includes a primary account number of a consumer who previously enrolled in a system to receive offers.

14. The method of claim 7 wherein the trigger record includes a primary account number identified as potentially eligible for a credit according to predetermined criteria.

15. The method of claim 7 further comprising initially sending the first offer to a consumer associated with the primary account number.

16. The method of claim 7 wherein the first offer includes a discount on a next payment transaction if the next payment transaction exceeds a predetermined amount.

17. The method of claim 7 wherein the first offer includes a discount on a next payment transaction that is made within a predetermined time period.

18. The method of claim 7 wherein a merchant is associated with the payment transaction and wherein the first offer includes a discount on a next payment transaction at a competing merchant.

19. The method of claim 7 wherein a merchant is associated with the transaction and wherein the first offer includes a discount on a payment transaction associated with the merchant if a predetermined number of payment transactions associated with the merchant are previously conducted.

20. A computer readable medium comprising computer readable program code embodied therein, said computer readable program code adapted to be executed by a processor to implement the method of claim 7.

21. A server computer comprising the processor; and the computer readable medium of claim 20 coupled to the processor.

22. A method comprising:
receiving an offer at a phone;
conducting a transaction associated with a primary account number using a consumer device; and
receiving a notification message at the phone substantially contemporaneously with conducting the transaction, wherein the notification message includes information about the offer and that the primary account was credited the amount of the offer.

23. The method of claim 22 further comprising:
previously providing enrollment information to receive notification messages relating to transactions associated with the primary account number.

24. The method of claim 23 wherein enrollment information includes a consumer name, a primary account number, and contact information for the consumer.

25. The method of claim 22 wherein a consumer device includes a payment card, a phone, or a personal digital assistant.

26. A computer readable medium comprising computer readable program code embodied therein, said computer readable program code adapted to be executed by a processor to implement the method of claim 22.

27. A server computer comprising the processor; and the computer readable medium of claim 26 coupled to the processor.

28. A phone comprising:
a processor;
an antenna coupled to the processor; and
a computer readable medium coupled to the processor, the computer readable medium comprising code for receiving a notification message substantially contemporaneously with a payment transaction conducted by a consumer, wherein the notification message relates to a transaction associated with a primary account number and includes information about an offer and that the primary account was credited the amount of the offer.

29. A method comprising:
receiving an offer at a personal navigation device;
conducting a transaction associated with a primary account number using a consumer device; and
receiving a notification message at the personal navigation device substantially contemporaneously with conducting the transaction, wherein the notification message includes information about the offer and that the primary account was credited the amount of the offer.

30. A method comprising:
receiving an offer at a television;
conducting a transaction associated with a primary account number using a consumer device; and
receiving a notification message at the television substantially contemporaneously with conducting the transaction, wherein the notification message includes information about the offer and that the primary account was credited the amount of the offer.
